(19) United States
(12) Patent Application Publication
(10) Pub. No.: US 2004/0019415 A1
(43) Pub. Date: Jan. 29, 2004

(54) Stratospheric flying object

(75) Inventors: Toshinori Hotta, Kanagawa (JP); Wakoto Akinaga, Kanagawa (JP)

Correspondence Address: OSTROLENK FABER GERB & SOFFEN, 1180 AVENUE OF THE AMERICAS, NEW YORK, NY, 100368403

(73) Assignee: NEC Toshiba Space Systems, Ltd.

(21) Appl. No.: 10/621,977

(22) Filed: Jul. 17, 2003

(30) Foreign Application Priority Data
Jul. 19, 2002 (JP) 2002-211534

(51) Int. Cl. G05D 3/00

(52) U.S. Cl. 701/6; 701/13

(57) ABSTRACT

A stratospheric flying object which is placed in the stratosphere of the earth has an airship-shaped flying object body, a despun platform unit mounted on the flying object body by a mount, and a controller for detecting an azimuthal angle of the despun platform unit in a horizontal plane and controlling the platform unit to face in a constant direction at all times within the horizontal plane. Preferably, directional antennas and telescopes for optical communications are mounted on the despun platform unit.

### BACKGROUND OF THE INVENTION

1. Field of the Invention

The present invention relates to the art of constructing a wide-area large-scale communication network based on electromagnetic waves including light, using a stratospheric flying object, and more particularly to a stratospheric flying object for use in such a wide-area large-scale communication network.

2. Description of the Related Art

Heretofore, as shown in FIG. 1, there has been used a communication system having artificial satellites such as communication satellites as intermediary mediums for international communications, particularly intercontinental communications and communications between wide areas. In FIG. 1, three communication satellites 91 are placed around earth 90 for relaying communications. Artificial satellites such as communication satellites are indispensable as intermediary mediums for communications with vehicles and ships moving on land and sea in a wide area and aircraft flying closely over land.

As various networks, typically the Internet, become more and more popular, communications are required to be carried out at higher rates and wider bands. So far, electromagnetic waves in the microwave or submillimeter wave band are employed for satellite communications between objects on land, including aircraft flying closely over land, and communication satellites. However, it is necessary to employ electromagnetic waves ranging from millimeter waves to light for communications at higher rates and wider bands. However, millimeter wave communications and optical communications have not yet been put to practical use in the satellite communication environment because no techniques have been available in the art to compensate for electromagnetic wave attenuations due to extremely long distances from the earth's surface to communication satellites and for electromagnetic wave attenuations which are caused by rainfalls and clouds and manifest themselves at higher electromagnetic wave frequencies.

In recent years, as disclosed in Japanese laid-open patent publication No. 5-227069 (JP, A, 5-227069), it has been proposed in the art to float airship-shaped platforms in the stratosphere that is about 20 km high from the earth's surface, and relay communications between transceivers placed on the earth's surface and transceivers on communication satellites with a transceiver on the stratospheric platform. According to the proposed system, electromagnetic wave attenuations which are caused by rainfalls and clouds particularly at high frequencies such as millimeter wave frequencies or higher that are required for high-rate, wide-band communications are compensated for by receiving and amplifying signals on the stratospheric platform. Communications between the stratospheric platforms and the communication satellites are performed using millimeter waves or light for thereby economically constructing a wide-area, large-scale communication network. With such a communication system, there is no need to take rainfall-dependent attenuations into account and the absorption by the atmosphere of millimeter waves and light can be ignored with respect to the communications between the stratospheric platforms and the communication satellites, making it possible to establish a millimeter-wave large-capacity communication link for the communications between the stratospheric platforms and the communication satellites. Between the earth's surface and the stratospheric platform, furthermore, K-type fading and duct-type fading can be ignored, and hence multipath propagation can also be ignored. It has also been proposed to relay communications with a plurality of stratospheric platforms without the need for communication satellites.

Japanese laid-open patent publications Nos. 2001-177461 and 2001-196988 (JP, P2001-177461A, and JP, P2001-196988A also disclose communication systems using a plurality of stratospheric platforms. Japanese laid-open patent publications Nos. 2000-357986 and 2000-78069 (JP, P2000-357986A and JP, P2000-78069A) reveal an airship control system capable of centralized management of a plurality of stratospheric platforms. Japanese laid-open patent publication No. 2000-124726 (JP, P2000-124726A) discloses an airship control system capable of centralized management of a plurality of stratospheric platforms and also discloses a mechanism for controlling the orientation of an antenna support member on each of the stratospheric platforms. Japanese laid-open patent publication No. 2000-295158 (JP, P2000-295158A) discloses an example of apparatus arrangement on a ground station in a communication system which uses a stratospheric platform.

For constructing a communication network for relaying communications with a stratospheric platform, it is necessary that the stratospheric platform be kept up in the sky at a fixed location, and be operated to turn around the fixed location for thereby preventing a particular surface of the platform from being exposed to sunlight for a long period of time and hence preventing the platform from suffering an unbalanced temperature distribution. When the stratospheric platform is turned, the relative direction of the body of the stratospheric platform with respect to a party, which is to communicate with, that is considered to be in a substantially constant location in terms of fixed coordinates on the earth, changes from time to time. Therefore, the direction of a directional antenna for radio communications or a telescope for optical communications on the stratospheric platform needs to be rotated with respect to the body of the stratospheric platform such that the directional antenna or the telescope faces in a constant direction at all times in terms of coordinates on the earth. However, there is no economical process of rotating altogether a plurality of directional antennas or telescopes for optical communications on the stratospheric platform.

### SUMMARY OF THE INVENTION

It is therefore an object of the present invention to provide a stratospheric flying object which is capable of controlling a plurality of directional antennas or telescopes for optical communications on a stratospheric platform to face in respective directions at all times without controlling the attitudes of the individual directional antennas or telescopes.

According to the present invention, the above object can be achieved by a stratospheric flying object for use in a stratosphere, comprising a flying object body, a platform unit mounted on the flying object body, and control means for detecting an azimuthal angle of the platform unit in a horizontal plane and actuating the platform unit to face in a constant direction at all times within the horizontal plane.

Preferably, the flying object body is in the form of an airship constructed to be adapted for flight in the stratosphere. The stratospheric flying object according to the present invention should preferably be placed at a constant stratospheric point up in the air of a certain geographical point and turned at all times about the constant stratospheric point when in operation.

With the above stratospheric flying object, a plurality of directional antennas and telescopes for optical communications which are mounted on the platform unit can economically be oriented in respective directions at all times. The stratospheric flying objects according to the present invention may be used to construct a wide-area, large-scale communication network economically.

The above and other objects, features, and advantages of the present invention will become apparent from the following description with reference to the accompanying drawings which illustrate an example of the present invention.

### BRIEF DESCRIPTION OF THE DRAWINGS

FIG. 1 is a view showing a conventional communication system;

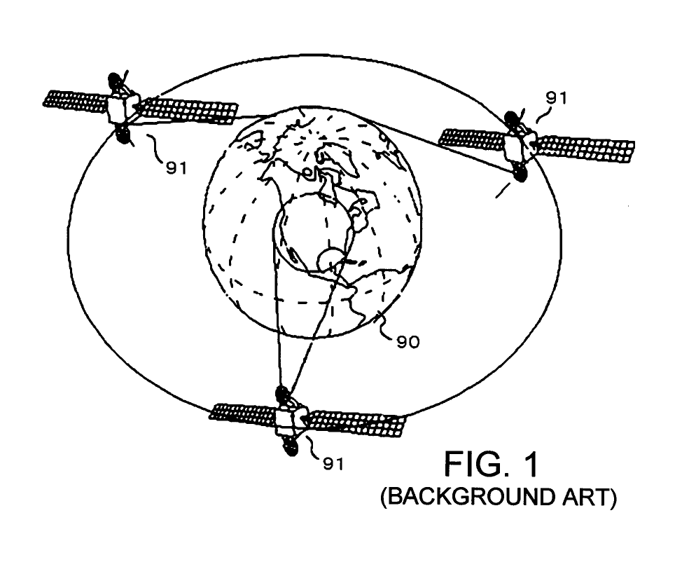

FIG. 2 is a schematic view showing a stratospheric flying object according to an embodiment of the present invention;

FIG. 3 is a schematic side elevational view of various devices mounted on a despun platform unit of the stratospheric flying object;

FIG. 4 is a block diagram of a control mechanism on the stratospheric flying object shown in FIG. 2; and

FIG. 5 is a schematic view showing a wide-area, large-scale network constructed of a plurality of stratospheric flying objects.

### DETAILED DESCRIPTION OF THE INVENTION

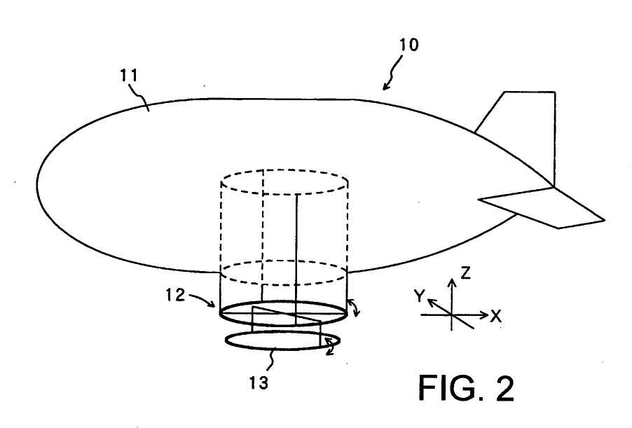

FIG. 2 schematically shows stratospheric platform 10 as a stratospheric flying object according to an embodiment of the present invention. As shown in FIG. 2, stratospheric platform 10 comprises flying object body 11 in the form of an airship envelope for use in the stratosphere, mount 12 suspended from a central region of flying object body 11, and despun platform unit 13 supported on mount 12. It is assumed that an axis oriented to the zenith direction through flying object body 11 staying still in the air is represented as a Z-axis, an axis lying in a plane which includes the longitudinal axis of the flying object and extending perpendicular to the Z-axis is represented as an X-axis, and an axis extending perpendicularly to both the X-axis and the Z-axis is represented as a Y-axis. Despun platform unit 13 can continuously be rotated about the Z-axis and can also be changed in attitude through respective angular ranges about the X-axis and the Y-axis by an actuating mechanism (not shown in FIG. 2).

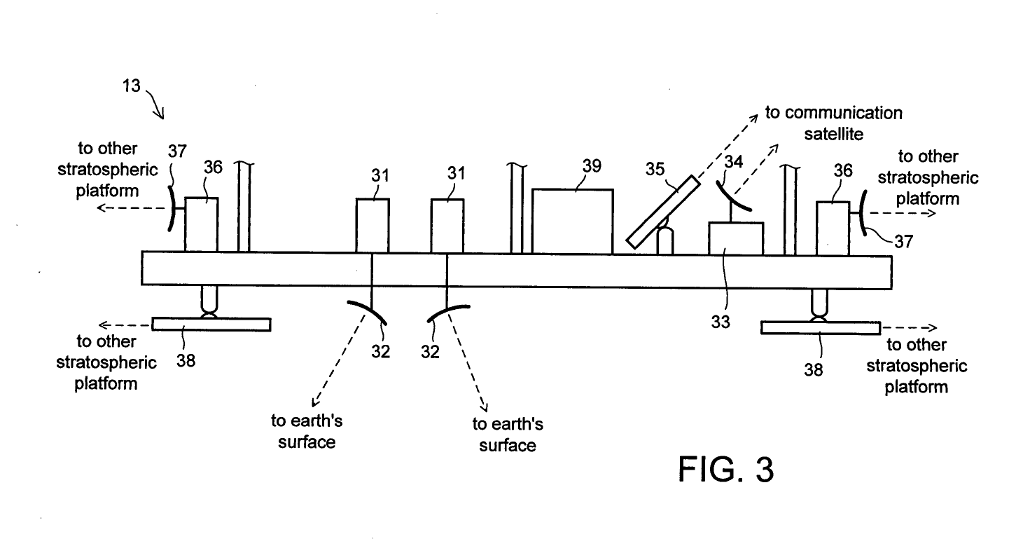

Stratospheric platform 10 has transceivers, directional antennas, and telescopes for optical communications, which are mounted on despun platform unit 13. Specifically, as shown in FIG. 3, transceivers 31 and directional antennas 32 which are used to transmit and receive signals to and from the earth's surface, and transceiver 33 and directional antenna 34 which are used to transmit and receive signals to and from a communication satellite, are mounted on despun platform unit 13 for relaying communications between transceivers on the earth's surface and the communication satellite. According to the present embodiment, optical communications using a laser beam are also carried out between stratospheric platform 10 and the communication satellites. Therefore, telescope 35 for optical communications is also mounted on despun platform unit 13 for transmitting and receiving optical signals. If a plurality of stratospheric platforms 10 are positioned within a visible range, then communications using electromagnetic waves or light are carried out between these stratospheric platforms 10. Consequently, transceivers 36, directional antennas 37, and telescopes 38 for optical communications are also mounted on despun platform unit 13 for performing communications with other stratospheric platforms. Despun platform unit 13 supports thereon circuit switching device 39 for connecting transceivers 31, 33, 36 and telescopes 35, 38.

The transceivers, the antennas, the telescopes for optical communications, and the circuit switching device described above will hereinafter be referred to collectively as a communication device.

As indicated by the broken lines in FIG. 2, mount 12 and despun platform unit 13 are retractable and can be stored in flying object body 11. When stratospheric platform 10 is to land on or take off from the earth's surface, mount 12 and despun platform unit 13 are stored in flying object body 11. Although not shown, flying object body 11 has a propeller and a propulsive energy source for flying stratospheric platform 10.

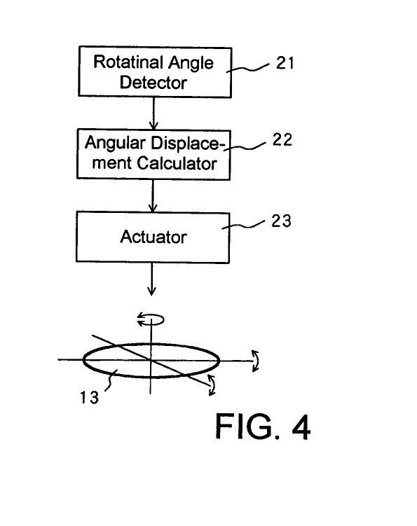

FIG. 4 shows in block form a mechanism for controlling the attitude of despun platform unit 13 of stratospheric platform 10 in flight. As shown in FIG. 4, the attitude controlling mechanism comprises rotational angle detector 21 for detecting an angle of angular movement of stratospheric platform 10 about the Z-axis, an angle of tilting movement of stratospheric platform 10 in the fore-and-aft direction (i.e., an angle of angular movement about the Y-axis), and an angle of tilting movement of stratospheric platform 10 in the lateral direction (i.e., an angle of angular movement about the X-axis), angular displacement calculator 22 for calculating angular displacements of despun platform unit 13 about the respective axes with respect to mount 12 based on the detected results by rotational angle detector 21 for keeping despun platform unit 13 in a constant attitude at all times with respect to the earth, and actuator 23 for rotating or changing the attitude of despun platform unit 13 based on the calculated angular displacements.

Detecting an angle of angular movement of despun platform unit 13 about the Z-axis is equivalent to detecting an azimuthal angle of despun platform unit 13 within a horizontal plane. Detecting angles of tilting movement of despun platform unit 13 in the fore-and-aft direction and the lateral direction is equivalent to detecting angles of tilting movement of despun platform unit 13 with respect to the horizontal plane.

Rotational angle detector 21 may comprise an inertial attitude detector such as a gyro or the like mounted on mount 12 or despun platform unit 13. Since stratospheric platform 10 is of a very large structure, a plurality of GPS (Global Positioning System) sensors may be mounted in different positions on stratospheric platform 10, and tilts of stratospheric platform 10 may be detected based on measured data from the GPS sensors. Actuator 23 may comprise a known attitude control mechanism capable of rotating despun platform unit 13 about the Z-axis with respect to mount 12 and changing tilts of despun platform unit 13 in the fore-and-aft direction and the lateral direction.

As stratospheric platform 10 is turned, its relative angle with respect to various points on the earth's surface changes from time to time. While stratospheric platform 10 is being turned, despun platform unit 13 is controlled to face in the same direction at all times within the horizontal plane, and is also rotated about the Z-axis for thereby orienting the directional antennas and the telescopes for optical communications in a constant direction or toward a certain point on the earth's surface at all times without being adversely affected by turning movements or directional changes of stratospheric platform 10. Even when stratospheric platform 10 is tilted in the fore-and-aft direction or the lateral direction due to air currents or the like, such a tilt is compensated for by despun platform unit 13 in the horizontal plane.

Consequently, the directional antennas and the telescopes on despun platform unit 13 can be oriented accurately in a constant direction or toward a certain point on the earth's surface at all times.

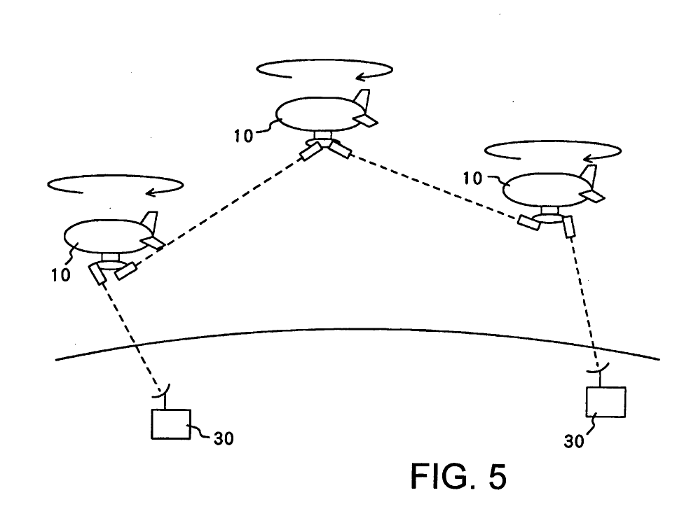

FIG. 5 schematically shows a wide-area, large-scale network constructed of a plurality of stratospheric platforms 10 described above. In FIG. 5, stratospheric platforms 10 relay radio communications between transceivers 30 on the earth's surface. Since turns and tilts of each of stratospheric platforms 10 do not adversely affect the despun platform unit thereof, the wide-area, large-scale network allows communications to be performed stably between stratospheric platforms 10 and transceivers 30 and also between stratospheric platforms 10.

While a preferred embodiment of the present invention has been described using specific terms, such description is for illustrative purposes only, and it is to be understood that changes and variations may be made without departing from the spirit or scope of the following claims.

What is claimed is:

1. A stratospheric flying object for use in a stratosphere, comprising:
a flying object body;
a platform unit mounted on said flying object body; and
control means for detecting an azimuthal angle of said platform unit in a horizontal plane and actuating said platform unit to face in a constant direction at all times within said horizontal plane.

2. The stratospheric flying object according to claim 1, for being placed at a constant location and turned about the constant location when in operation.

3. The stratospheric flying object according to claim 1, further comprising a mount suspended from said flying object body, said platform unit being supported on said mount and rotatable with respect to said mount.

4. The stratospheric flying object according to claim 3, wherein said mount and said platform unit can be stored in said flying object body.

5. The stratospheric flying object according to claim 1, wherein said control means detects a tilt of said platform unit with respect to said horizontal plane and actuates said platform unit to compensate for the detected tilt.

6. The stratospheric flying object according to claim 5, wherein said control means comprises:
a rotational angle detector for detecting said azimuthal angle and said tilt of said platform unit;
an angular displacement calculator for calculating angular displacements of said platform unit about respective axes thereof based on a detection result by said rotational angle detector; and
an actuator for rotating said platform unit to change an attitude thereof based on the calculated angular displacements.

7. The stratospheric flying object according to claim 1, further comprising a communication device mounted on said platform unit for communications with another stratospheric flying object.

8. The stratospheric flying object according to claim 1, further comprising at least one of a first communication device mounted on said platform unit for communications with a station on the earth's surface and a second communication device mounted on said platform unit for communications with an artificial satellite.
